(19) United States
(12) Patent Application Publication
(10) Pub. No.: US 2023/0333802 A1
(43) Pub. Date: Oct. 19, 2023

(54) TERMINAL DEVICE AND ELECTRONIC MANUAL DISPLAY METHOD

(71) Applicant: SHARP KABUSHIKI KAISHA, Osaka (JP)

(72) Inventor: KENICHIROH IMAYOSHI, Osaka (JP)

(73) Assignee: SHARP KABUSHIKI KAISHA, Osaka (JP)

(21) Appl. No.: 18/135,027

(22) Filed: Apr. 14, 2023

(30) Foreign Application Priority Data
Apr. 14, 2022 (JP) 2022-067141

(51) Int. Cl. G06F 3/14

(52) U.S. Cl. CPC G06F 3/1454

(57) ABSTRACT

A terminal device includes a communicator that performs transmission and reception of various data with an external apparatus having an operation panel; a display that displays various types of information for a user; an operation acceptor that accepts an operation performed by the user; a storage that stores a program of an electronic manual application that displays an electronic manual of the apparatus on the display; and a controller that controls the communicator, the display, the operation acceptor, and the storage. when the electronic manual application is activated, the controller causes the communicator to receive data of display content of the operation panel of the apparatus and causes the display to display content of the electronic manual determined in advance to correspond to the display content of the operation panel.

### CROSS-REFERENCE TO RELATED APPLICATION

The present application claims priority from Japanese Application JP2022-067141, the content of which is hereby incorporated by reference into this application.

### BACKGROUND OF THE INVENTION

### 1. Field of the Invention

The present disclosure relates to a terminal device and an electronic manual display method.

### 2. Description of the Related Art

In general, image forming apparatuses, such as a multifunctional peripheral (MFP), having a function of displaying an electronic manual on an operation panel have been used.

However, in MFPs with the electronic manual display function, a display area of the operation panel is limited, and when the electronic manual is displayed, the electronic manual occupies a large portion of a screen of the operation panel.

Since a user may not operate such an MFP while viewing the electronic manual on the operation panel, the user is required to close the electronic manual before operating the MFP or display the electronic manual of the MFP on an external terminal device, such as a smartphone.

Here, as a general technique for displaying an electronic manual on an external terminal device, manual data for displaying a manual for an application corresponding to identification information received from a terminal device used by a user is transmitted to the terminal device, so that the user can find a desired portion in the manual more easily than before.

### SUMMARY OF THE INVENTION

However, in the general technique for displaying an electronic manual on an external terminal device, an electronic manual is generally displayed completely separately from an operation screen currently displayed on an operation panel of an MFP. Therefore, the user is required to search the electronic manual displayed on the external terminal device for an item that matches the operation screen currently displayed on the operation panel of the MFP, which is not very convenient for the user.

An aspect of this disclosure is made in consideration of the above circumstances, and the present disclosure provides a terminal device and an electronic manual display method that realize more user-friendly display of an electronic manual of an apparatus having an operation panel on a terminal device than before.

According to an aspect of the present disclosure, a terminal device includes a communicator that performs transmission and reception of various data with an external apparatus having an operation panel, a display that displays various types of information for a user, an operation acceptor that accepts an operation performed by the user, a storage that stores a program of an electronic manual application that displays an electronic manual of the apparatus on the display, and a controller that controls the communicator, the display, the operation acceptor, and the storage. When the electronic manual application is activated, the controller causes the communicator to receive data of display content of the operation panel of the apparatus and causes the display to display content of the electronic manual determined in advance to correspond to the display content of the operation panel.

According to an aspect of the present disclosure, an electronic manual display method includes performing communication by transmission and reception of various data with an external apparatus having an operation panel, displaying various types of information for a user, accepting an operation performed by the user, and storing a program of an electronic manual application that displays an electronic manual of the apparatus in the displaying. Data of display content of the operation panel of the apparatus is received in the communication when the electronic manual application is activated, and content of the electronic manual determined in advance to correspond to the display content of the operation panel is displayed in the displaying.

According to an aspect of the present disclosure, a term “terminal device” represents a terminal device that has a communication function, such as a smartphone or a tablet terminal. A term “external apparatus having an operation panel” represents an apparatus having an operation panel and a communication function, such as a photocopier, a multifunctional peripheral, or a multifunctional peripheral (MFP) that has functions other than copying in addition to the function of copying, a television set, a DVD recorder, a personal computer (PC), or an electronic blackboard. A “display” and an “operation acceptor” may be separately configured or a display and an operation acceptor may be integrally configured as a touch panel superposed on a display panel. A “storage that stores a program for an electronic manual application” stores a program of an electronic manual application installed in the terminal device, but the program may also be stored in an external server.

According to an aspect of the present disclosure, since a page of interest of an electronic manual is displayed in conjunction with display content of an operation panel of an apparatus when the electronic manual of the apparatus having the operation panel is displayed on a terminal device, the terminal device capable of performing more user-friendly display of the electronic manual and an electronic manual display method are realized.

### BRIEF DESCRIPTION OF THE DRAWINGS

FIG. 1 is a diagram illustrating an example of an image forming system according to a first embodiment of the present disclosure.

FIG. 2 is a block diagram schematically illustrating a configuration of a digital multifunctional peripheral in FIG. 1.

FIG. 3 is a block diagram schematically illustrating a configuration of a mobile terminal of FIG. 1.

FIG. 4 is a block diagram schematically illustrating a configuration of a server of FIG. 1.

FIG. 5 is a sequence diagram illustrating a flow of a display process of an electronic manual application of the mobile terminal linked to display content of the operation panel of the digital multifunctional peripheral in the image forming system shown in FIG. 1.

FIG. 6 is a diagram illustrating the relationship between a screen of the operation panel of the digital multifunctional peripheral and a screen of the electronic manual application on the mobile terminal, where FIGS. 6(A) to 6(D) are diagrams illustrating screens of the operation panel of the digital multifunctional peripheral, and FIGS. 6(E) to 6(H) are diagrams illustrating screens of the electronic manual application on the mobile terminal corresponding to the screens in FIGS. 6(A) to 6(D), respectively.

FIG. 7 is a sequence diagram illustrating a flow of a process of displaying an electronic manual application of a mobile terminal linked to display content of an operation panel of a digital multifunctional peripheral in an image forming system according to a second embodiment of the present disclosure.

FIG. 8 is a diagram illustrating the relationship between a screen of the operation panel of the digital multifunctional peripheral and a screen of the electronic manual application of the mobile terminal according to the second embodiment of the present disclosure, where FIGS. 8(A) to 8(C) are diagrams illustrating screens of the operation panel of the digital multifunctional peripheral, and FIGS. 8(E) to 8(H) are diagrams illustrating screens of the electronic manual application on the mobile terminal.

FIG. 9 is a sequence diagram illustrating a process performed when a button “Read Manual” is touched in a process of displaying an electronic manual application of a mobile terminal linked to display content of an operation panel of a digital multifunctional peripheral in an image forming system according to a third embodiment of the present disclosure.

FIG. 10 is a diagram illustrating the process performed when the button “Read Manual” is touched in the relationship between a screen of the operation panel of the digital multifunctional peripheral and a screen of the electronic manual application of the mobile terminal according to the third embodiment of the present disclosure, where FIGS. 10(A) and 10(B) are diagrams illustrating screens of the operation panel of the digital multifunctional peripheral, and FIGS. 10(C) and 10(D) are diagrams illustrating screens of the electronic manual application on the mobile terminal.

FIG. 11 is a sequence diagram illustrating a process performed when a long press is performed on a button “Setting 2-1” in the process of displaying the electronic manual application of the mobile terminal linked to display content of the operation panel of the digital multifunctional peripheral in the image forming system according to the third embodiment of the present disclosure.

FIG. 12 is a diagram illustrating the process performed when a long press is performed on the button “Setting 2-1” in the relationship between a screen of the operation panel of the digital multifunctional peripheral and a screen of the electronic manual application of the mobile terminal according to the third embodiment of the present disclosure, where FIGS. 12(A) and 12(B) are diagrams illustrating screens of the operation panel of the digital multifunctional peripheral, and FIGS. 12(C) and 12(D) are diagrams illustrating screens of the electronic manual application on the mobile terminal.

FIG. 13 is a diagram illustrating the relationship between a screen of the operation panel of the digital multifunctional peripheral and a screen of the electronic manual application of the mobile terminal according to the third embodiment of the present disclosure, where FIGS. 13(A) to 13(D) are diagrams illustrating screens of the operation panel of the digital multifunctional peripheral, and FIGS. 13(E) to 13(G) are diagrams illustrating screens of the electronic manual application on the mobile terminal.

FIG. 14 is a sequence diagram illustrating a flow of a process of displaying an electronic manual application of a mobile terminal linked to display content of an operation panel of a digital multifunctional peripheral in an image forming system according to a fourth embodiment of the present disclosure.

FIG. 15 is a diagram illustrating the relationship between a screen of the operation panel of the digital multifunctional peripheral and a screen of the electronic manual application of the mobile terminal according to the fourth embodiment of the present disclosure, where FIGS. 15(A) and 15(B) are diagrams illustrating screens of the operation panel of the digital multifunctional peripheral, and FIGS. 15(C) to 15(E) are diagrams illustrating screens of the electronic manual application on the mobile terminal.

### DETAILED DESCRIPTION OF THE INVENTION

Preferred embodiments of the present disclosure will now be described.

In the terminal device according to an aspect of the present disclosure, the communicator may receive an instruction for displaying the electronic manual accepted by the operation panel of the apparatus, and when the communicator receives the instruction for displaying the electronic manual, the controller may cause the communicator to receive data of display content of the operation panel of the apparatus and cause the display to display the electronic manual determined in advance to correspond to the display content of the operation panel.

Accordingly, since a page of interest of the electronic manual may be displayed in conjunction with display content of the operation panel only when a user performs an operation of displaying the electronic manual, such as a touch on a display button for the electronic manual, on the operation panel of the apparatus, the terminal device capable of performing more user-friendly display of the electronic manual may be realized.

In the terminal device according to an aspect of the present disclosure, when the display content of the operation panel includes a selection button for accepting a selection performed by the user, the display may display a selection button corresponding to content of the electronic manual determined in advance to correspond to the display content of the operation panel, and when the operation acceptor accepts a selection of the corresponding selection button while the display is displaying the electronic manual, the controller may cause the communicator to transmit an instruction for reflecting a result of the selection of the corresponding selection button to the apparatus.

Accordingly, when the electronic manual of the apparatus having the operation panel is displayed on the terminal device, a page of interest in the electronic manual is displayed in conjunction with display content of the operation panel of the apparatus, and on the other hand, even when the user selects a corresponding selection button displayed on a screen of the electronic manual application of the terminal device, a result of the selection of the corresponding selection button is reflected on the screen of the operation panel, and therefore, the terminal device capable of performing more user-friendly display of the electronic manual may be realized.

In the terminal device according to an aspect of the present disclosure, when the display may display a linkage setting button that accepts a setting as to whether linkage between the operation panel of the apparatus and the electronic manual application is to be enabled, and the controller may cause the display to display content of the electronic manual determined in advance to correspond to the display content of the operation panel only when the linkage is set to be enabled.

Accordingly, since a page of interest of the electronic manual is displayed in conjunction with display content of the operation panel of the apparatus only in a case where a linkage setting with the operation panel is enabled when the electronic manual of the apparatus having the operation panel is displayed on the terminal device, the terminal device capable of performing more user-friendly display of the electronic manual may be realized.

When the user selects a corresponding selection button displayed on the screen of the electronic manual application of the terminal device, a result of the selection of the corresponding selection button may be reflected on the screen of the operation panel only when the linkage setting with the operation panel is enabled.

Hereinafter, embodiments of the present disclosure will be described further in detail with reference to the accompanying drawings. Note that the following description is illustrative in all respects and should not be construed as limiting the embodiments of the present disclosure.

### First Embodiment

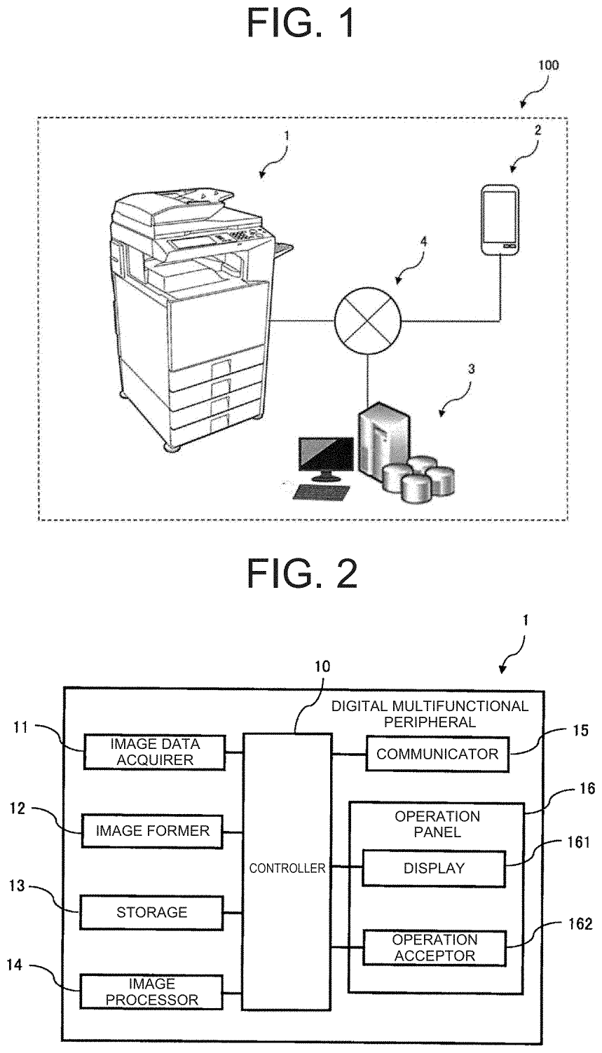

An image forming system 100 including a mobile terminal 2 that is an example of a terminal device according to an embodiment of the present disclosure will be described with reference to FIGS. 1 to 3.

FIG. 1 is an explanatory view of an example of the image forming system 100 according to a first embodiment of the present disclosure.

As illustrated in FIG. 1, the image forming system 100 includes a digital multifunctional peripheral 1, a mobile terminal 2, and a server 3 that are connected to one another through a wired or wireless network 4.

The digital multifunctional peripheral 1 according to the first embodiment of the present disclosure is an apparatus, such as a multifunctional peripheral or an MFP, that digitally processes image data, and that has a copy function, a printer function, a scanner function, and a facsimile function.

FIG. 2 is a block diagram schematically illustrating a configuration of the digital multifunctional peripheral 1 of FIG. 1.

As illustrated in FIG. 2, the digital multifunctional peripheral 1 includes a controller 10, an image data acquirer 11, an image former 12, a storage 13, an image processor 14, a communicator 15, and an operation panel 16.

Schematic Configuration of Digital Multifunctional Peripheral 1

In the following, components of the digital multifunctional peripheral 1 will be described.

The controller 10 comprehensively controls the digital multifunctional peripheral 1 and includes a central processing unit (CPU), a random access memory (RAM), a read only memory (ROM), and various interface circuits. In order to control entire operation of the digital multifunctional peripheral 1, the controller 10 monitors and controls detection of each sensor, and all loads on a motor, a clutch, the operation panel 16, and the like.

The image data acquirer 11 is a component that detects and reads a document placed on a document table or a document transported from a document tray so as to generate image data. The image data acquirer 11 may acquire image data recorded on a universal serial bus (USB), image data from an external terminal through the communicator 15, and the like.

The image former 12 is a component that prints out image data, which is acquired by the image data acquirer 11 and is processed by the image processor 14, onto a sheet.

The storage 13 is an element or a storage medium that stores information required to realize the various functions of the digital multifunctional peripheral 1, a control program, and the like. For example, a semiconductor device, such as a RAM or a ROM, or a storage medium, such as a hard disk, a flash storage, or an SSD, is used.

The storage 13 stores data required for execution of a job, such as information on a job of printing or the like, image data, and the like. The storage 13 stores data of a job that has been executed as history information. The storage 13 also stores information, such as a login name and a password of the user, stored for user authentication.

Note that the programs and the data may be held in different devices. For example, the data may be held in a region of a hard disk drive, whereas the programs may be held in a region of a flash storage.

The image processor 14 converts image data supplied from the image data acquirer 11 into appropriate electric signals based on an analysis result of an instruction of a job, such as a print job acquired through an operation acceptor 162 so as to perform a process, such as size enlargement and size reduction, on the image data to be suitable for an output format.

The communicator 15 communicates with the mobile terminal 2 or the like via the network 4 to transmit and receive various types of information.

The operation panel 16 includes a display panel constituted by a liquid crystal panel or the like and a touch panel employing a capacitive method or the like that overlaps with the display panel and detects a position touched by a finger, and the operation panel 16 includes a display 161 and the operation acceptor 162.

The display 161 displays various types of information. The display 161 is constituted by, for example, a cathode ray tube (CRT) display, a liquid crystal display, or an electroluminescence (EL) display, and is a display device, such as a monitor or a line display, for an operating system or application software to display electronic data of a processing state or the like.

The controller 10 causes the display 161 to display operation and a state of the digital multifunctional peripheral 1.

The operation acceptor 162 is an interface for operating the digital multifunctional peripheral 1, and accepts an instruction issued by the user.

Schematic Configuration of Mobile Terminal 2

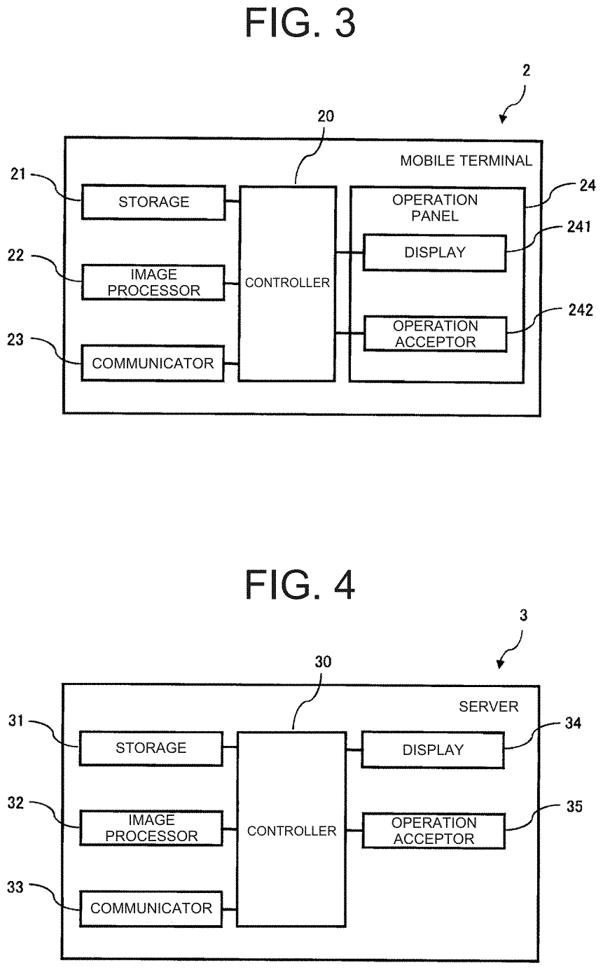

FIG. 3 is a block diagram schematically illustrating a configuration of the mobile terminal 2 of FIG. 1.

As shown in FIG. 3, the mobile terminal 2 includes a controller 20, a storage 21, an image processor 22, a communicator 23, and an operation panel 24.

In the following, the individual components of the mobile terminal 2 will be described.

The controller 20 integrally controls the mobile terminal 2, and includes a CPU, a RAM, a ROM, and various interface circuits.

The storage 21 is a storage element or a storage medium that stores information required for realizing various functions of the mobile terminal 2 and a control program. For example, a semiconductor device, such as a RAM or a ROM, or a storage medium, such as a hard disk, a flash storage, or an SSD, is used.

The storage 21 stores data of an electronic manual application for the digital multifunctional peripheral 1.

The image processor 22 performs a process, such as size enlargement and size reduction, on an image displayed on the display 241 based on an instruction issued from the operation acceptor 242 so that the image is suitable for an output format.

The communicator 23 communicates with the digital multifunctional peripheral 1, the server 3, and the like via the network 4, so as to transmit and receive various types of information, such as screen information and an electronic manual.

The operation panel 24 includes a display panel constituted by a liquid crystal panel or the like and a touch panel employing a capacitive method or the like that overlaps with the display panel and detects a position touched by a finger, and the operation panel 24 includes a display 241 and an operation acceptor 242.

The display 241 displays various types of information. The display 241 is constituted by, for example, a cathode ray tube (CRT) display, a liquid crystal display, or an electroluminescence (EL) display, and is a display device, such as a monitor or a line display, for an operating system or application software to display electronic data of a processing state or the like.

The controller 20 displays, through the display 241, operation and a state of the mobile terminal 2.

The operation acceptor 242 is an interface for operating the mobile terminal 2, and accepts an instruction issued by the user.

Schematic Configuration of Server 3

FIG. 4 is a block diagram schematically illustrating a configuration of the server 3 of FIG. 1.

As shown in FIG. 4, the server 3 includes a controller 30, a storage 31, an image processor 32, a communicator 33, a display 34, and an operation acceptor 35.

In the following, the individual components of the server 3 will be described.

The controller 30 integrally controls the server 3, and includes a CPU, a RAM, a ROM, and various interface circuits.

The storage 31 is a storage element or a storage medium that stores information required for realizing various functions of the server 3 and a control program. For example, a semiconductor device, such as a RAM or a ROM, or a storage medium, such as a hard disk, a flash storage, or an SSD, is used.

The storage 31 stores data of an electronic manual of the digital multifunctional peripheral 1.

The image processor 32 performs a process, such as size enlargement and size reduction, on an image displayed on the display 34 based on an instruction issued by the operation acceptor 35 so that the image is suitable for an output format.

The communicator 33 communicates with the digital multifunctional peripheral 1, the mobile terminal 2, and the like via the network 4, so as to transmit and receive various types of information, such as screen information.

The display section 34 has a display panel constituted by a liquid crystal panel or the like, and displays various types of information. The display 34 is constituted by, for example, a CRT display, a liquid crystal display, or an EL display, and is a display device, such as a monitor or a line display, for an operating system or application software to display electronic data of a processing state or the like.

The controller 30 displays, through the display 34, operation and a state of the server 3.

The operation acceptor 35 is an interface for operating the server 3, and accepts an instruction issued by an administrator.

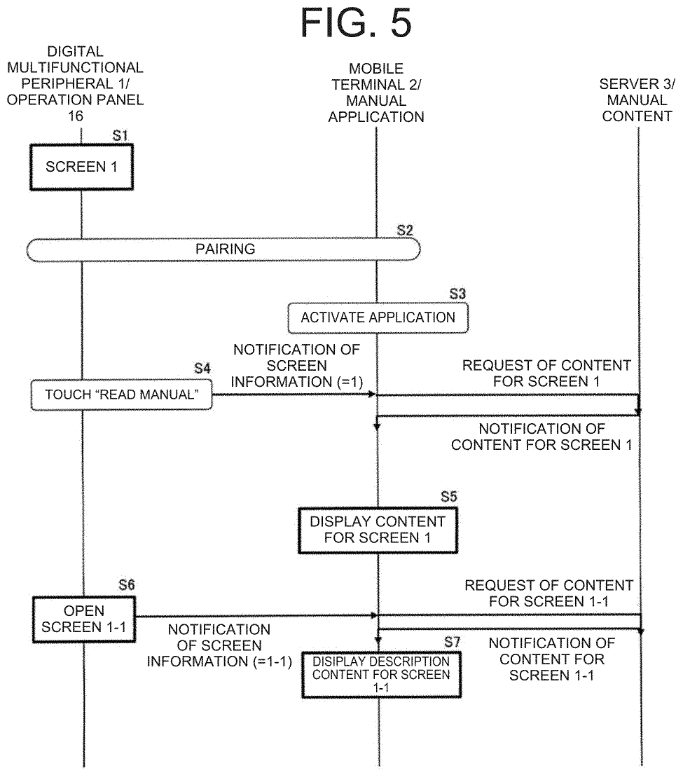

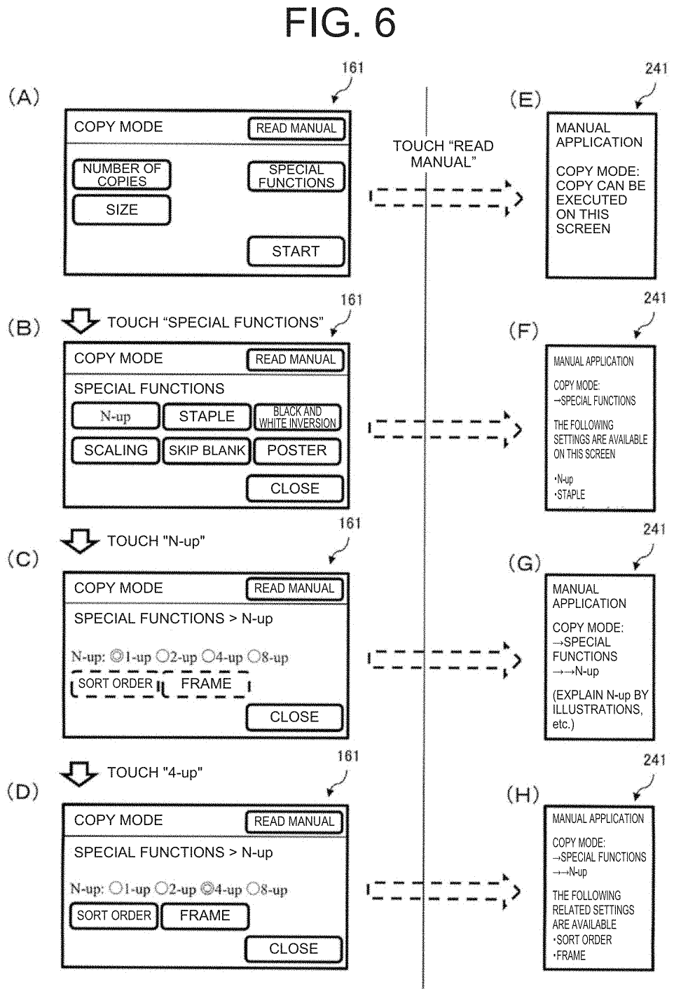

Example of Display Process of Electronic Manual Application of Mobile Terminal 2 Linked to Display Content of Operation Panel 16 of Digital Multifunctional peripheral 1 in Image Forming System 100 of First Embodiment of Present Disclosure Next, an example of a display process of an electronic manual application of the mobile terminal 2 linked to display content of the operation panel 16 of the digital multifunctional peripheral 1 in the image forming system 100 of the first embodiment of the present disclosure will be described with reference to FIGS. 5 and 6.

FIG. 5 is a sequence diagram illustrating a flow of a display process of an electronic manual application of the mobile terminal 2 linked to display content of the operation panel 16 of the digital multifunctional peripheral 1 in the image forming system 100 shown in FIG. 1.

In step S1 of FIG. 5, it is assumed that a screen 1 is displayed on the operation panel 16 of the digital multifunctional peripheral 1 (step S1).

Here, after the user pairs the mobile terminal 2 with the digital multifunctional peripheral 1 in step S2 (step S2), the electronic manual application on the mobile terminal 2 is activated in step S3 (step S3).

Subsequently, when the user touches a button “Read Manual” on the screen 1 in step S4 (step S4), the digital multifunctional peripheral 1 notifies the electronic manual application of screen information of the screen 1.

The electronic manual application requests content for the screen 1 from the server 3, and when the server 3 notifies the electronic manual application of the content for the screen 1, the electronic manual application displays the content for the screen 1 on the display 241 in step S5 (step S5).

FIG. 6 is a diagram illustrating the relationship between a screen of the operation panel 16 of the digital multifunctional peripheral 1 and a screen of the electronic manual application on the mobile terminal 2. FIGS. 6(A) to 6(D) are diagrams illustrating screens of the operation panel 16 of the digital multifunctional peripheral 1, and FIGS. 6(E) to 6(H) are diagrams illustrating screens of the electronic manual application on the mobile terminal 2 corresponding to the screens in FIGS. 6(A) to 6(D), respectively.

As shown in FIG. 6(A), a basic screen of a copy mode is displayed as the screen 1 on the operation panel 16 of the digital multifunctional peripheral 1. The basic screen displays buttons “Read Manual”, “Number of Copies” and “Size” of copies, “Special Functions”, and “Start”.

Here, after the user pairs the mobile terminal 2 with the digital multifunctional peripheral 1, the electronic manual application on the mobile terminal 2 is activated, and when the user touches the button “Read Manual”, the electronic manual application of the mobile terminal 2 displays a description of the copy mode indicating “Copy can be executed on this screen” as shown in FIG. 6(E).

Subsequently, when the user touches the button “Open Screen 1-1” on the operation panel 16 of the digital multifunctional peripheral 1 in step S6 of FIG. 5 (step S6), the digital multifunctional peripheral 1 notifies the electronic manual application of screen information of a screen 1-1.

The electronic manual application requests content for the screen 1-1 from the server 3, and when the server 3 notifies the electronic manual application of the content for the screen 1-1, the electronic manual application displays the content for the screen 1-1 on the display 241 in step S7 (step S7).

In the basic screen of the copy mode in FIG. 6(A), when the user touches the button “Special Functions”, a list of special functions of the copy mode is displayed on the operation panel 16, as shown in FIG. 6(B).

The special functions include buttons “N-up”, “Staple”, “Black and White Inversion”, “Scaling”, “Skip Blank”, and “Poster”. The button “Close” is also displayed at a lower right portion in the screen.

On the other hand, as shown in FIG. 6(F), the screen of the electronic manual application of the mobile terminal 2 also displays details of the various functions including the functions “N-up” and “Staple” as an explanation of the special functions in the copy mode, with a message “The following settings are available on this screen”.

In the screen in FIG. 6(B), when the user touches the button “N-up”, a list of N-up in the copy mode is displayed on the operation panel 16, as shown in FIG. 6(C).

As the N-up function, “1-up”, “2-up”, “4-up”, and “8-up” are displayed in a selectable manner, and setting buttons “Sort Order” and “Frame” that are grayed out and a button “Close” are also displayed.

Furthermore, as shown in FIG. 6(G), the electronic manual application of the mobile terminal 2 displays a screen with illustrations or other information explaining the special function of N-up in the copy mode.

Furthermore, when the user selects the button “4-up” on the screen in FIG. 6(C), the settings “Sort Order” and “Frame” are displayed as the 4-up functions, as shown in FIG. 6(D).

At this time, as shown in FIG. 6(H), the electronic manual application on the mobile terminal 2 displays a message “The following related settings are available. Sort Order, Frame”.

In this way, the electronic manual of the digital multifunctional peripheral 1 is displayed in the electronic manual application of the mobile terminal 2, and a page of interest of the electronic manual is displayed in conjunction with the contents displayed on the operation panel 16 of the digital multifunctional peripheral 1, so that the image forming system 100 that is more convenient for the user than before can be realized.

In general, the operation panel 16 of the digital multifunctional peripheral 1 has a limited display area, and therefore, by displaying the electronic manual linked to display content of the operation panel 16 on the electronic manual application of the mobile terminal 2, such as a smartphone, the user can refer to a page of the electronic manual corresponding to content of an operation on the operation panel 16 while operating the operation panel 16.

Although the image forming system 100 of the first embodiment includes the server 3, the image forming system 100 may not include the server 3, but may request data from the electronic manual stored in the storage 15 of the digital multifunctional peripheral 1 and display the data. Alternatively, the data of the electronic manual may be directly downloaded and displayed in the mobile terminal 2.

### Second Embodiment

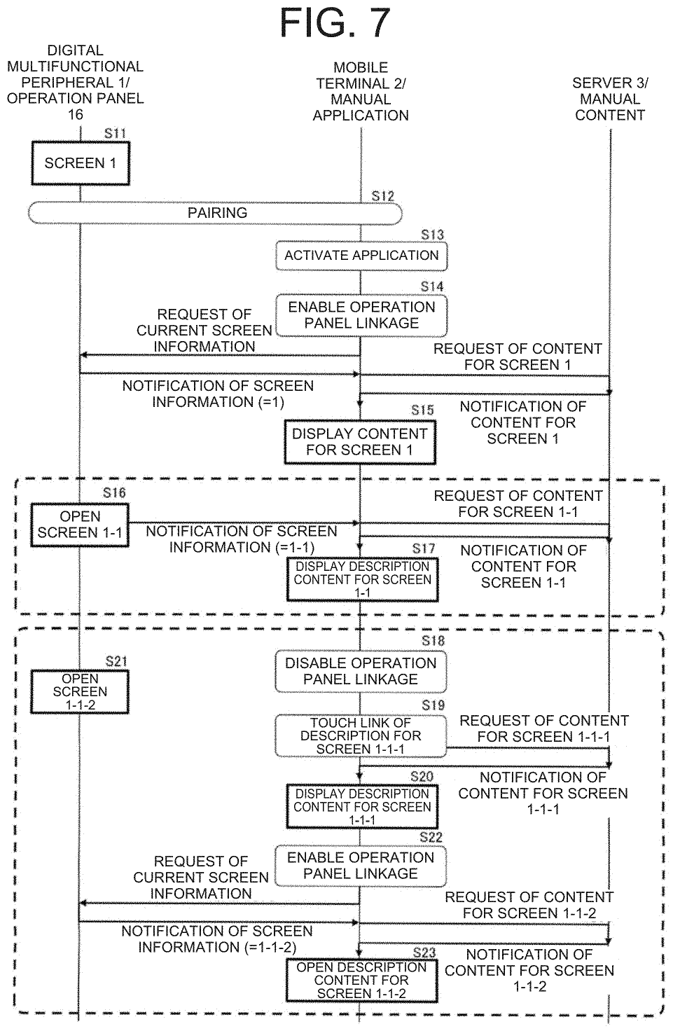

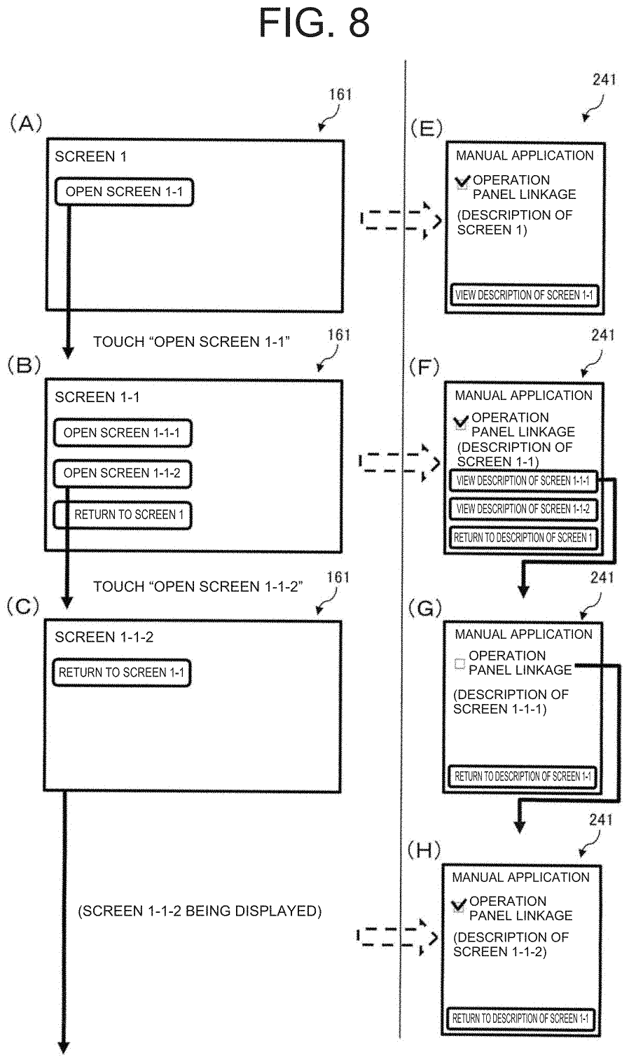

Next, an example of a display process of an electronic manual application of a mobile terminal 2 linked to display content of an operation panel 16 of a digital multifunctional peripheral 1 in an image forming system 100 of a second embodiment of the present disclosure will be described with reference to FIGS. 7 and 8.

The schematic configurations of the image forming system 100, the digital multifunctional peripheral 1, the mobile terminal 2, and a server 3 according to the second embodiment are the same as those illustrated in FIGS. 1 to 4 (First Embodiment), respectively, and therefore, descriptions thereof are omitted.

FIG. 7 is a sequence diagram illustrating a flow of a display process of an electronic manual application of the mobile terminal 2 linked to display content of the operation panel 16 of the digital multifunctional peripheral 1 in the image forming system 100 according to the second embodiment of the present disclosure.

In the image forming system 100 according to the first embodiment, a page of interest of the electronic manual of the mobile terminal 2 is displayed in conjunction with display content of the operation panel 16 of the digital multifunctional peripheral 1. On the other hand, in the image forming system 100 according to the second embodiment, availability of linkage between the operation panel 16 of the digital multifunctional peripheral 1 and the electronic manual application of the mobile terminal 2 may be set.

In step S11 of FIG. 7, it is assumed that a screen 1 is displayed on the operation panel 16 of the digital multifunctional peripheral 1 (step S11).

Here, after the user pairs the mobile terminal 2 with the digital multifunctional peripheral 1 in step S12 (step S12), the electronic manual application of the mobile terminal 2 is activated in step S13 (step S13).

Thereafter, when the user enables a linkage with the operation panel in the electronic manual application of the mobile terminal 2 in step S14 (step S14), the electronic manual application requests current screen information from the digital multifunctional peripheral 1.

Subsequently, the digital multifunctional peripheral 1 then notifies the electronic manual application of the screen information for the screen 1, and the electronic manual application requests content for the screen 1 from the server 3.

When the server 3 notifies the electronic manual application of the content for the screen 1, the electronic manual application displays the content for the screen 1 on a display 241 in step S15 (step S15).

FIG. 8 is a diagram illustrating the relationship between a screen of the operation panel 16 of the digital multifunctional peripheral 1 and a screen of the electronic manual application on the mobile terminal 2. FIGS. 8(A) to 8(C) are diagrams illustrating screens of the operation panel 16 of the digital multifunctional peripheral 1, and FIGS. 8(E) to 8(H) are diagrams illustrating screens of the electronic manual application on the mobile terminal 2.

As shown in FIG. 8(A), the screen 1 and a button “Open Screen 1-1” are displayed on the operation panel 16 of the digital multifunctional peripheral 1.

Here, when the electronic manual application on the mobile terminal 2 is activated after the user pairs the mobile terminal 2 with the digital multifunctional peripheral 1, a screen of the electronic manual application is displayed on the display 241 of the mobile terminal 2 as shown in FIG. 8(E).

In the screen of the electronic manual application, a setting “Operation Panel Linkage” is checked to be enabled, and a description of the screen 1 and a button “View Description of Screen 1-1” are displayed.

Subsequently, when the user touches the button “Open Screen 1-1” on the operation panel 16 of the digital multifunctional peripheral 1 in step S16 of FIG. 7 (step S16), the digital multifunctional peripheral 1 notifies the electronic manual application of screen information of the screen 1-1.

The electronic manual application requests content for the screen 1-1 from the server 3, and when the server 3 notifies the electronic manual application of the content for the screen 1-1, the electronic manual application displays the content for the screen 1-1 on the display 241 in step S17 (step S17).

In the screen 1 in FIG. 8(A), when the user touches the button “Open Screen 1-1”, the screen 1-1 is displayed on the operation panel 16, as shown in FIG. 8(B).

Buttons “Open Screen 1-1-1”, “Open Screen 1-1-2”, and “Return to Screen 1” are displayed on the screen 1-1.

On the other hand, as shown in FIG. 8(F), a description of the screen 1-1 and the buttons “View Description of Screen 1-1-1”, “View Description of Screen 1-1-2”, and “Return to Description of Screen 1” are displayed on the screen of the electronic manual application of the mobile terminal 2.

Subsequently, it is assumed that, after the user disables “Operation Panel Linkage” of the electronic manual application of the mobile terminal 2 in step S18 of FIG. 7 (step S18), the user touches a link of the description for the screen 1-1-1 in step S19 (step S19).

In this case, the electronic manual application requests content for the screen 1-1-1 from the server 3, and when the server 3 notifies the electronic manual application of the content for the screen 1-1-1, the electronic manual application displays the content for the screen 1-1-1 on the display 241 in step S20 (step S20).

In FIG. 8(F), it is assumed that the user unchecks and disables the setting “Operation Panel Linkage” on the screen of the electronic manual application of the mobile terminal 2, and then touches a button “View Description of Screen 1-1-1”.

At this time, although a description of the screen 1-1-1 and the button “Return to Description of Screen 1-1” are displayed on the screen of the electronic manual application as shown in FIG. 8(G), the screen 1-1 remains displayed as the screen of the operation panel 16 of the digital multifunctional peripheral 1 as shown in FIG. 8(B).

Subsequently, when the user touches the button “Open Screen 1-1-2” on the operation panel 16 of the digital multifunctional peripheral 1 in step S21 of FIG. 7 (step S21), the screen 1-1-2 is displayed. However, when the operation panel linkage is disabled, the screen 1-1-2 is not reflected in the electronic manual application.

In the screen 1-1 shown in FIG. 8(B), when the user touches the button “Open Screen 1-1-2”, the screen 1-1-2 is displayed on the operation panel 16 as shown in FIG. 8(C).

A button “Return to Screen 1-1” is displayed on the screen 1-1-2.

On the other hand, the screen of the electronic manual application of the mobile terminal 2 does not reflect the switching of the screen of the operation panel 16 of the digital multifunctional peripheral 1 when the operation panel linkage is disabled.

Thereafter, when the user enables “Operation Panel Linkage” in the electronic manual application of the mobile terminal 2 in step S22 of FIG. 7 (step S22), the electronic manual application requests current screen information from the digital multifunctional peripheral 1.

When the digital multifunctional peripheral 1 then notifies the electronic manual application of screen information of the screen 1-1-2, the electronic manual application requests content for the screen 1-1-2 from the server 3.

When the server 3 notifies the electronic manual application of the content for the screen 1-1-2, the electronic manual application displays the content for the screen 1-1-2 on the display 241 in step S23 (step S23).

When the user checks and enables the setting “Operation Panel Linkage” on the screen of the electronic manual application of the mobile terminal 2 in FIG. 8(G), the description of the screen 1-1-2 and the button “Return to Description of Screen 1-1” are also displayed on the screen of the electronic manual application of the mobile terminal 2 as shown in FIG. 8(H).

In this way, the electronic manual of the digital multifunctional peripheral 1 is displayed in the electronic manual application of the mobile terminal 2, and a page of interest of the electronic manual is displayed in conjunction with content displayed on the operation panel 16 of the digital multifunctional peripheral 1 only when a setting of linkage with the operation panel 16 is enabled, so that the image forming system 100 that is more convenient for the user than before can be realized.

Note that, although the linkage setting button is displayed on the mobile terminal 2 in the second embodiment, the linkage setting button may be displayed on the operation panel 16 of the digital multifunctional peripheral 1.

The operation panel 16 of the digital multifunctional peripheral 1 and the electronic manual application of the mobile terminal 2 may be linked to each other only by a normal touch on a button, for example, irrespective of enabling/disabling of the operation panel linkage button, but may not be linked to each other when a long press is performed on the button, so that a determination as to whether the linkage is to be enabled is made depending on a way of press of the button.

### Third Embodiment

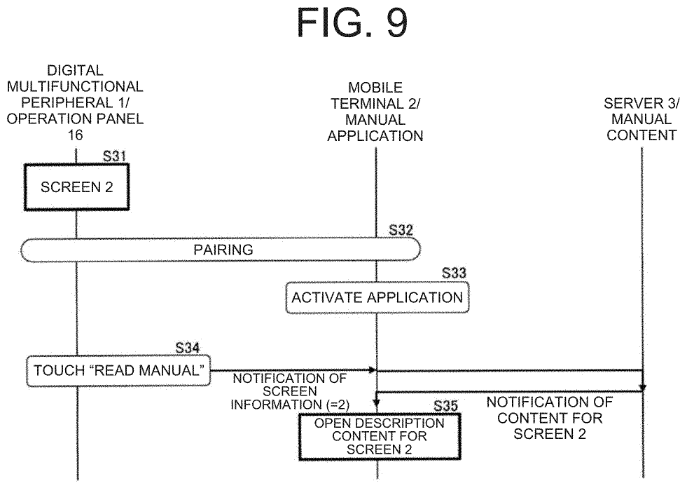

Next, an example of a display process of an electronic manual application of a mobile terminal 2 linked to display content of an operation panel 16 of a digital multifunctional peripheral 1 in an image forming system 100 of a third embodiment of the present disclosure will be described with reference to FIGS. 9 to 13.

The schematic configurations of the image forming system 100, the digital multifunctional peripheral 1, the mobile terminal 2, and a server 3 according to the third embodiment are the same as those illustrated in FIGS. 1 to 4 (First Embodiment), respectively, and therefore, descriptions thereof are omitted.

In the image forming system 100 according to the first embodiment, a page of the electronic manual of the mobile terminal 2 corresponding to a screen of interest is displayed only by a touch operation on the screen of the operation panel 16 of the digital multifunctional peripheral 1.

On the other hand, in the image forming system 100 according to the third embodiment, also when a long press is performed on an arbitrary setting button on the screen of the digital multifunctional peripheral 1, a page of the electronic manual of the mobile terminal 2 corresponding to the setting button may be displayed.

FIG. 9 is a sequence diagram illustrating a flow of a display process of an electronic manual application of the mobile terminal 2 linked to display content of the operation panel 16 of the digital multifunctional peripheral 1 in the image forming system 100 according to the third embodiment of the present disclosure.

In step S31 of FIG. 9, it is assumed that a screen 2 is displayed on the operation panel 16 of the digital multifunctional peripheral 1 (step S31).

Here, after the user pairs the mobile terminal 2 with the digital multifunctional peripheral 1 in step S32 (step S32), the electronic manual application on the mobile terminal 2 is activated in step S33 (step S33).

Subsequently, in step S34, when the user touches a button “Read Manual” on the screen 2 (step S34), the digital multifunctional peripheral 1 notifies the electronic manual application of screen information of the screen 2.

The electronic manual application requests content for the screen 2 from the server 3, and when the server 3 notifies the electronic manual application of the content for the screen 2, the electronic manual application displays the content for the screen 2 on a display 241 in step S35 (step S35).

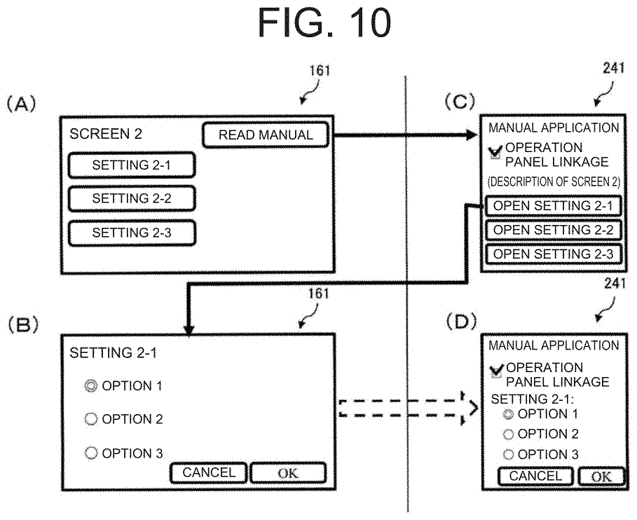

FIG. 10 is a diagram illustrating a process performed when the button “Read Manual” is touched in the relationship between the screen of the operation panel 16 of the digital multifunctional peripheral 1 and the screen of the electronic manual application of the mobile terminal 2 according to the third embodiment of the present disclosure. FIGS. 10(A) and 10(B) are diagrams illustrating screens of the operation panel 16 of the digital multifunctional peripheral 1, and FIGS. 10(C) and 10(D) are diagrams illustrating screens of the electronic manual application on the mobile terminal 2.

As shown in FIG. 10(A), the screen 2 is displayed on the operation panel 16 of the digital multifunctional peripheral 1. On the screen 2, buttons “Read Manual”, “Setting 2-1”, “Setting 2-2” and “Setting 2-3” are displayed.

Here, after the user pairs the mobile terminal 2 with the digital multifunctional peripheral 1, the electronic manual application on the mobile terminal 2 is activated, and when the user touches the button “Read Manual”, a description of the screen 2 is displayed on the electronic manual application of the mobile terminal 2 as shown in FIG. 10(C).

In the example in FIG. 10(C), the operation panel linkage setting is enabled, and buttons “Open Setting 2-1”, “Open Setting 2-2”, and “Open Setting 2-3” are displayed along with the description of the screen 2.

Here, when the user touches the button “Open Setting 2-1”, a screen for the setting 2-1 is displayed on the operation panel 16 of the digital multifunctional peripheral 1 as shown in FIG. 10(B).

In the example in FIG. 10(B), three options, that is, “Option 1”, “Option 2”, and “Option 3”, are displayed with buttons “Cancel” and “OK” below the three options.

As shown in FIG. 10(D), the screen of the setting 2-1 is also reflected in the electronic manual application of the mobile terminal 2.

In the example in FIG. 10(D), the operation panel linkage setting is enabled and the three options, that is, “Option 1”, “Option 2”, and “Option 3”, are displayed with buttons “Cancel” and “OK” below the three options.

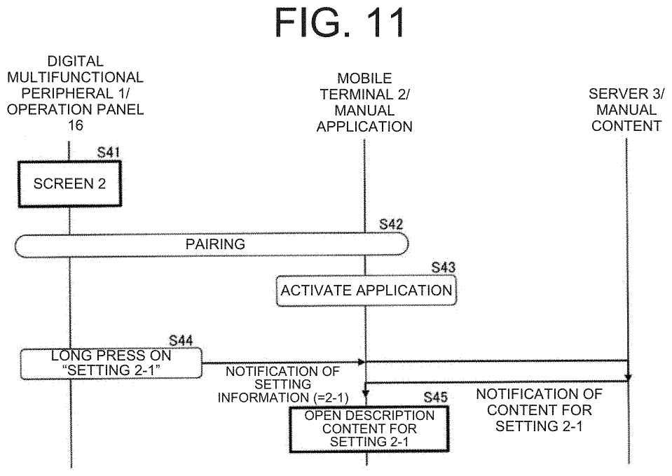

FIG. 11 is a sequence diagram illustrating a process performed when a long press is performed on the button “Setting 2-1” in the display process of the electronic manual application of the mobile terminal 2 linked to content displayed on the operation panel 16 of the digital multifunctional peripheral 1 in the image forming system 100 according to the third embodiment of the present disclosure.

In step S41 of FIG. 11, it is assumed that the screen 2 is displayed on the operation panel 16 of the digital multifunctional peripheral 1 (step S41).

Here, after the user pairs the mobile terminal 2 with the digital multifunctional peripheral 1 in step S42 (step S42), the electronic manual application on the mobile terminal 2 is activated in step S43 (step S43).

Subsequently, in step S44, when the user performs a long press on the button “Setting 2-1” on the screen 2 (step S44), the digital multifunctional peripheral 1 notifies the electronic manual application of setting information of the setting 2-1.

The electronic manual application requests content for the setting 2-1 from the server 3, and when the server 3 notifies the electronic manual application of the content for the setting 2-1, the electronic manual application displays the content for the setting 2-1 on the display 241 in step S45 (step S45).

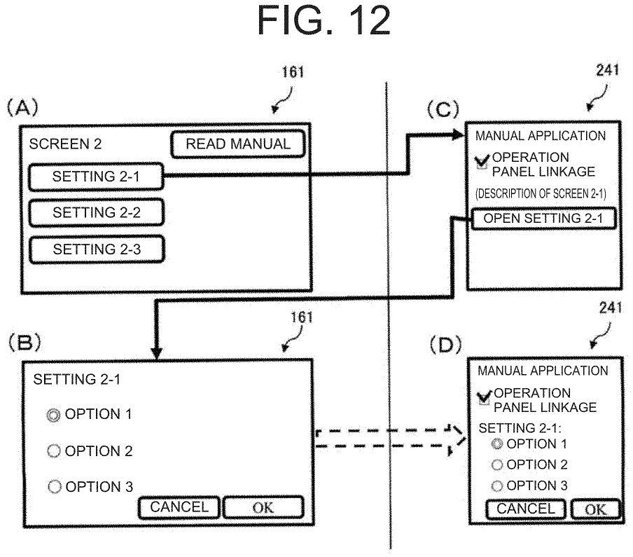

FIG. 12 is a diagram illustrating the process performed when a long press is performed on the button “Setting 2-1” in the relationship between a screen of the operation panel 16 of the digital multifunctional peripheral 1 and a screen of the electronic manual application of the mobile terminal 2 according to the third embodiment of the present disclosure. FIGS. 12(A) and 12(B) are diagrams illustrating screens of the operation panel 16 of the digital multifunctional peripheral 1, and FIGS. 12(C) and 12(D) are diagrams illustrating screens of the electronic manual application on the mobile terminal 2.

As shown in FIG. 12(A), the screen 2 is displayed on the operation panel 16 of the digital multifunctional peripheral 1. On the screen 2, buttons “Read Manual”, “Setting 2-1”, “Setting 2-2” and “Setting 2-3” are displayed.

Here, after the user pairs the mobile terminal 2 with the digital multifunctional peripheral 1, the electronic manual application on the mobile terminal 2 is activated, and when the user performs a long press on the button “Setting 2-1”, a description of the setting 2-1 is displayed on the electronic manual application of the mobile terminal 2 as shown in FIG. 12(C).

In the example in FIG. 12(C), the operation panel linkage setting is enabled, and a button “Open Setting 2-1” is displayed along with the description of the setting 2-1.

Here, when the user touches the button “Open Setting 2-1”, a screen for the setting 2-1 is displayed on the operation panel 16 of the digital multifunctional peripheral 1 as shown in FIG. 12(B).

In the example in FIG. 12(B), three options, that is, “Option 1”, “Option 2”, and “Option 3”, are displayed with buttons “Cancel” and “OK” below the three options.

As shown in FIG. 12(D), the screen of the setting 2-1 is also reflected in the electronic manual application of the mobile terminal 2.

In the example in FIG. 12(D), the operation panel linkage setting is enabled and the three options, that is, “Option 1”, “Option 2”, and “Option 3”, are displayed with buttons “Cancel” and “OK” below the three options.

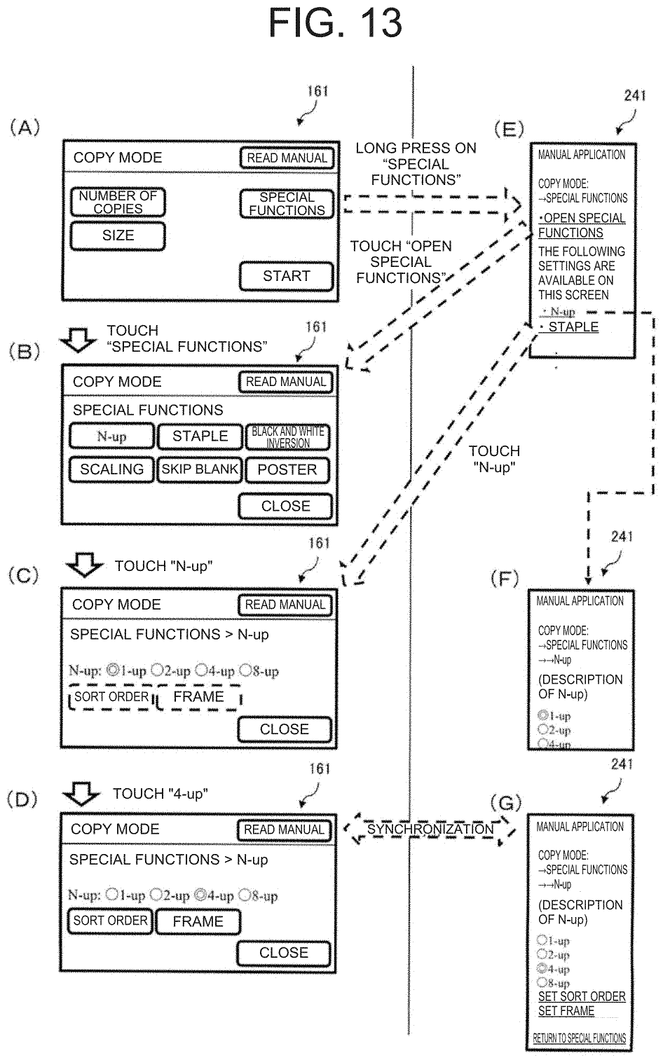

FIG. 13 is a diagram illustrating the relationship between a screen of the operation panel 16 of the digital multifunctional peripheral 1 and a screen of the electronic manual application of the mobile terminal 2 according to the third embodiment of the present disclosure. FIGS. 13(A) to 13(D) are diagrams illustrating screens of the operation panel 16 of the digital multifunctional peripheral 1, and FIGS. 13(E) to 13(G) are diagrams illustrating screens of the electronic manual application on the mobile terminal 2.

As shown in FIG. 13(A), a basic screen of a copy mode is displayed on the operation panel 16 of the digital multifunctional peripheral 1. The basic screen displays buttons “Read Manual”, “Number of Copies” and “Size” of copies, “Special Functions”, and “Start”.

It is assumed here that, after the user pairs the mobile terminal 2 with the digital multifunctional peripheral 1, the electronic manual application of the mobile terminal 2 is activated.

Subsequently, when the user performs a long press on the button “Special Functions” on the basic screen in the copy mode displayed on the operation panel 16, a screen for describing the special functions is displayed on the electronic manual application of the mobile terminal 2 as shown in FIG. 13(E).

In the example in FIG. 13(E), a button “Open Special Functions” is displayed, and a list of buttons for special functions, such as “N-up” and “Staple”, is displayed below a message “The following settings are available on this screen”.

Here, when the user touches the button “Special Functions” on the operation panel 16 of the digital multifunctional peripheral 1, a list of special functions in the copy mode is displayed on the operation panel 16 as shown in FIG. 13(B).

Furthermore, when the button “Open Special Functions” is touched in the electronic manual application of the mobile terminal 2 in FIG. 13(E), the list of special functions is displayed on the operation panel 16 as shown in FIG. 13(B).

On a screen for the list of the special functions, buttons “N-up”, “Staple”, “Black and White Inversion”, “Scaling”, “Skip Blank”, and “Poster” are displayed. The button “Close” is also displayed at a lower right portion in the screen.

In the screen shown in FIG. 13(B), when the user touches the button “N-up”, a list of N-up in the copy mode is displayed on the operation panel 16 as shown in FIG. 13(C).

Furthermore, also when the button “N-up” is touched in the electronic manual application of the mobile terminal 2 in FIG. 13(E), the list of special functions is displayed on the operation panel 16 as shown in FIG. 13(C).

On a screen for the N-up function, “1-up”, “2-up”, “4-up”, and “8-up” are displayed in a selectable manner, and setting buttons “Sort Order” and “Frame” that are grayed out and a button “Close” are also displayed.

At this time, as shown in FIG. 13(F), an appropriate screen is displayed in the electronic manual application of mobile terminal 2, along with a description of N-up.

Furthermore, when the user selects the button “4-up” on the screen shown in FIG. 13(C), the button “4-up” is also selected in the electronic manual application of the mobile terminal 2 as shown in FIG. 13(G).

In this way, when the electronic manual of the digital multifunctional peripheral 1 is displayed in the electronic manual application of the mobile terminal 2 and a long press is performed on one of the buttons on the operation panel 16 of the digital multifunctional peripheral 1, a corresponding description page is displayed in the electronic manual application of the mobile terminal 2 so that the image forming system 100 that is more convenient for the user than before can be realized.

### Fourth Embodiment

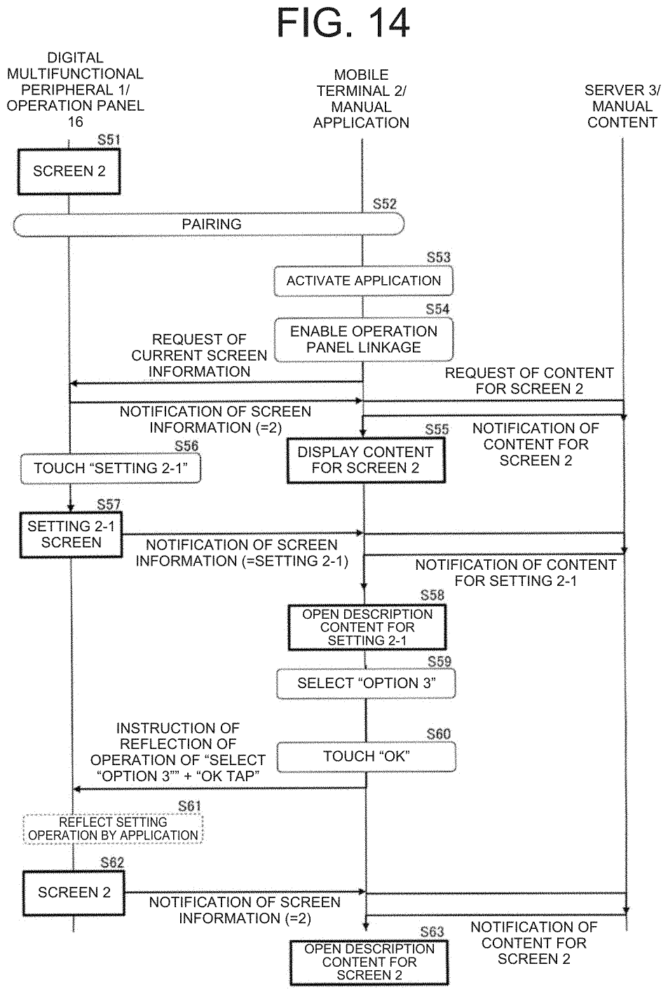

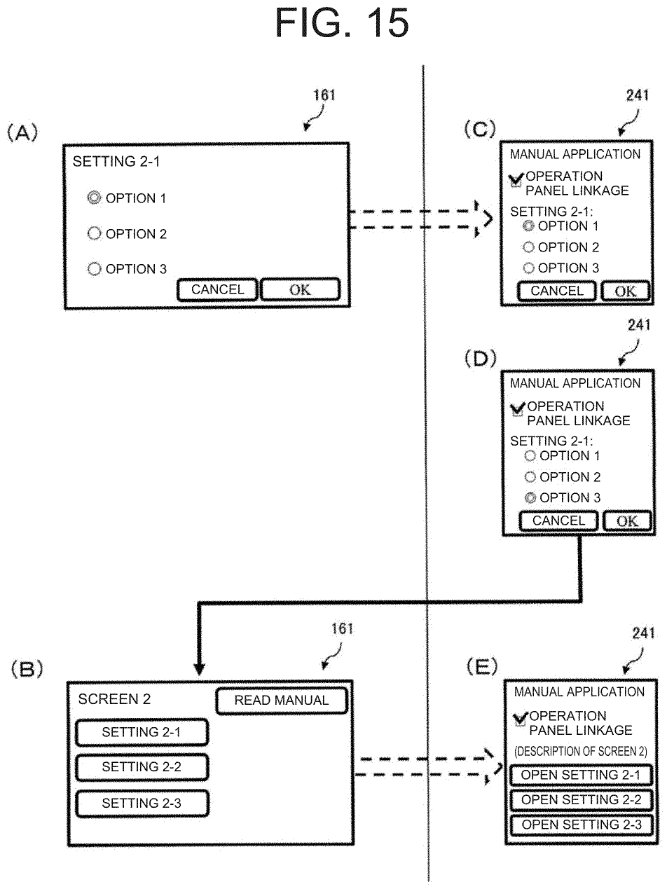

Next, an example of a process of displaying an operation panel 16 of a digital multifunctional peripheral 1 linked to an electronic manual application of a mobile terminal 2 in an image forming system 100 of a fourth embodiment of the present disclosure will be described with reference to FIGS. 14 and 15.

The schematic configurations of the image forming system 100, the digital multifunctional peripheral 1, the mobile terminal 2, and a server 3 according to the fourth embodiment are the same as those illustrated in FIGS. 1 to 4 (First Embodiment), respectively, and therefore, descriptions thereof are omitted.

In the image forming system 100 according to the first embodiment, an option selected on the screen of the operation panel 16 of the digital multifunctional peripheral 1 is reflected on the screen of the electronic manual application of the mobile terminal 2 corresponding to the screen of the operation panel 16.

On the other hand, in the image forming system 100 of the fourth embodiment, when an option displayed on a screen of an electronic manual application of the mobile terminal 2 is selected, a result of the selection is also reflected on the screen of the operation panel 16 of the digital multifunctional peripheral 1.

FIG. 14 is a sequence diagram illustrating a flow of a display process of an electronic manual application of the mobile terminal 2 linked to display content of the operation panel 16 of the digital multifunctional peripheral 1 in the image forming system 100 according to the fourth embodiment of the present disclosure.

In step S51 of FIG. 14, it is assumed that a screen 2 is displayed on the operation panel 16 of the digital multifunctional peripheral 1 (step S51).

Here, after the user pairs the mobile terminal 2 with the digital multifunctional peripheral 1 in step S52 (step S52), the electronic manual application on the mobile terminal 2 is activated in step S53 (step S53).

Thereafter, when the user enables linkage with the operation panel in the electronic manual application of the mobile terminal 2 in step S54 (step S54), the electronic manual application requests current screen information from the digital multifunctional peripheral 1.

Subsequently, when the digital multifunctional peripheral 1 notifies the electronic manual application of the screen information for the screen 2, the electronic manual application requests content for the screen 2 from the server 3.

When the server 3 notifies the electronic manual application of the content for the screen 2, the electronic manual application displays the content for the screen 2 on the display 241 in step S55 (step S55).

Subsequently, in step S56, when the user touches the button “Screen 2-1” on the operation panel 16 of the digital multifunctional peripheral 1 (step S56), the digital multifunctional peripheral 1 displays the screen 2-1 on the operation panel 16 in step S57 (step S57), and in addition, notifies the electronic manual application of screen information of the screen 2-1.

The electronic manual application requests content for the screen 2-1 from the server 3, and when the server 3 notifies the electronic manual application of the content for the screen 2-1, the electronic manual application displays the content for the screen 2-1 on the display 241 in step S58 (step S58).

FIG. 15 is a diagram illustrating the relationship between a screen of the operation panel 16 of the digital multifunctional peripheral 1 and a screen of the electronic manual application of the mobile terminal 2 according to the fourth embodiment of the present disclosure. FIGS. 15(A) and 15(B) are diagrams illustrating screens of the operation panel of the digital multifunctional peripheral 1, and FIGS. 15(C) to 15(E) are diagrams illustrating screens of the electronic manual application on the mobile terminal 2.

In the example in FIG. 15(A), three options, that is, “Option 1”, “Option 2”, and “Option 3”, are displayed with buttons “Cancel” and “OK” below the three options.

As shown in FIG. 15(C), the screen of the setting 2-1 is also reflected in the electronic manual application of the mobile terminal 2.

In the example in FIG. 15(C), the operation panel linkage setting is enabled and three options, that is, “Option 1”, “Option 2”, and “Option 3”, are displayed with buttons “Cancel” and “OK” below the three options.

Subsequently, it is assumed that the user selects “Option 3” on the screen of the electronic manual application of the mobile terminal 2 in step S59 of FIG. 14 (step S59) and then touches the button “OK” in step S60 (step S60).

At this time, a result of the user's selection in the electronic manual application is reflected on the screen of the operation panel 16 of the digital multifunctional peripheral 1 in step S61 (step S61).

Subsequently, when the screen 2 is returned on the operation panel 16 of the digital multifunctional peripheral 1 in step S62 (step S62) and the digital multifunctional peripheral 1 notifies the electronic manual application of the screen information for the screen 2, the electronic manual application requests content for the screen 2 from the server 3.

When the server 3 notifies the electronic manual application of the content for the screen 2, the electronic manual application displays the content for the screen 2 on the display 241 in step S63 (step S63).

In FIG. 15(D), it is assumed that the user selects “Option 3” on the screen of the electronic manual application of the mobile terminal 2 and subsequently touches the button “OK”.

At this time, the screen 2 is displayed on the operation panel 16 of the digital multifunctional peripheral 1 as shown in FIG. 15(B), and is reflected on the screen of the electronic manual application of the mobile terminal 2 as shown in FIG. 15(E).

In this way, also when the electronic manual of the digital multifunctional peripheral 1 is displayed in the electronic manual application of the mobile terminal 2 and one of the options displayed on the screen of the electronic manual application of the mobile terminal 2, a result of the selection is reflected on the screen of the operation panel 16 of the digital multifunctional peripheral 1, so that the image forming system 100 that is more convenient for the user than before can be realized.

Preferred embodiments of the present disclosure also include combinations of any of the above-described embodiments.

Various modifications may be made to the present disclosure in addition to the above-described embodiments. Such modifications are not be construed as falling outside the scope of the present disclosure. The present disclosure should embrace the claims and their equivalents, and all modifications within the scope of the claims.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A terminal device comprising:
a communicator that performs transmission and reception of various data with an external apparatus having an operation panel;
a display that displays various types of information for a user;
an operation acceptor that accepts an operation performed by the user;
a storage that stores a program of an electronic manual application that displays an electronic manual of the apparatus on the display; and
a controller that controls the communicator, the display, the operation acceptor, and the storage, wherein
when the electronic manual application is activated, the controller causes the communicator to receive data of display content of the operation panel of the apparatus and causes the display to display content of the electronic manual determined in advance to correspond to the display content of the operation panel.

2. The terminal device according to claim 1, wherein
the communicator receives an instruction for displaying the electronic manual accepted by the operation panel of the apparatus, and
when the communicator receives the instruction for displaying the electronic manual, the controller causes the communicator to receive the data of the display content of the operation panel of the apparatus and causes the display to display the electronic manual determined in advance to correspond to the display content of the operation panel.

3. The terminal device according to claim 1, wherein
when the display content of the operation panel includes a selection button for accepting a selection performed by the user, the display displays a selection button corresponding to content of the electronic manual determined in advance to correspond to the display content of the operation panel, and
when the operation acceptor accepts a selection of the corresponding selection button while the display is displaying the electronic manual, the controller causes the communicator to transmit an instruction for reflecting a result of the selection of the corresponding selection button to the apparatus.

4. The terminal device according to claim 1, wherein
when the display displays a linkage setting button that accepts a setting as to whether a linkage between the operation panel of the apparatus and the electronic manual application is to be enabled, and
the controller causes the display to display content of the electronic manual determined in advance to correspond to the display content of the operation panel only when the linkage is set to be enabled.

5. An electronic manual display method comprising:
performing communication by transmission and reception of various data with an external apparatus having an operation panel;
displaying various types of information for a user;
accepting an operation performed by the user; and
storing a program of an electronic manual application that displays an electronic manual of the apparatus in the displaying, wherein
data of display content of the operation panel of the apparatus is received in the communication when the electronic manual application is activated, and content of the electronic manual determined in advance to correspond to the display content of the operation panel is displayed in the displaying.
